(19) United States
(12) Patent Application Publication
(10) Pub. No.: US 2002/0040964 A1
(43) Pub. Date: Apr. 11, 2002

(54) Moisture sensor

(75) Inventors: Gunther Dausmann, Erding (DE); Zishao Yang, Erding (DE); Gerhard Hochenbleicher, Furstenfeldbruck (DE)

Correspondence Address: Rocco S. Barrese, Esq., DILWORTH & BARRESE, LLP, 333 Earle Ovington Blvd., Uniondale, NY, 11553, US

(73) Assignee: HSM Holographic Systems Munchen GmbH

(21) Appl. No.: 09/970,811

(22) Filed: Oct. 4, 2001

(30) Foreign Application Priority Data
Oct. 5, 2000 (DE) 100 49 401.3

(51) Int. Cl. G02B 6/42

(52) U.S. Cl. 250/227.25

(57) ABSTRACT

The invention relates to a moisture sensor in which light is coupled into a light guiding layer by a light source, undergoes total reflection there as long as the surrounding medium has a moisture lower than a threshold moisture and does not undergo total reflection if the moisture of the medium exceeds a threshold moisture, having an uncoupling element to uncouple the light from the light guiding layer and a detector for the uncoupled light. In accordance with the invention, a reflection hologram is provided on a part of the light guiding layer which, when a light ray is incident at the angle with which the light propagates in the light guiding layer, reconstructs a light ray which extends substantially counter to the incident light ray. The invention furthermore relates to a corresponding moisture sensor in which a pane, in particular an aeroplane or vehicle windscreen, is used as the light guiding layer.

The invention relates to a moisture sensor having the features of the preamble of claim 1 or the features of the preamble of claim 4 respectively.

Rain sensors are today used in the motor vehicle industry, for example, in order to achieve an automatic control of the windscreen wipers. In a known rain sensor, a light ray is coupled into the windscreen from the inside with the aid of a ray coupling device, with an angle being selected which, under normal circumstances, that is with dry outside air, results in a total reflection of the light ray within the windscreen. The light ray is uncoupled again at another point and guided to a detector. The coupling and uncoupling devices are located at the inside of the windscreen. If a water droplet or moisture is incident to the outside of the windscreen, then the refractive index of the medium adjacent to the windscreen changes in this region. With a suitable selection of the coupling angle, a total reflection no longer takes place inside the windscreen with such a moist outside medium. The light ray exits the pane and does not reach the sensor. This loss of intensity can be detected with the aid of a light intensity measuring instrument. If its signal is, for example, less than a pre-set threshold, the windscreen wipers are switched on.

The coupling or uncoupling of the ray can, for example, be effected with the help of prisms which are fitted to the windscreen from the inside and are also made of glass. The base area of these prisms are fitted to the inside of the windscreen, with the angle of the prisms being selected such that the side surface of the prism being perpendicular to the direction in which the ray should be propagated within the windscreen. In this way, a coupling or uncoupling of a light ray is possible which moves inside the windscreen under total reflection at the interface between the windscreen and the surrounding medium.

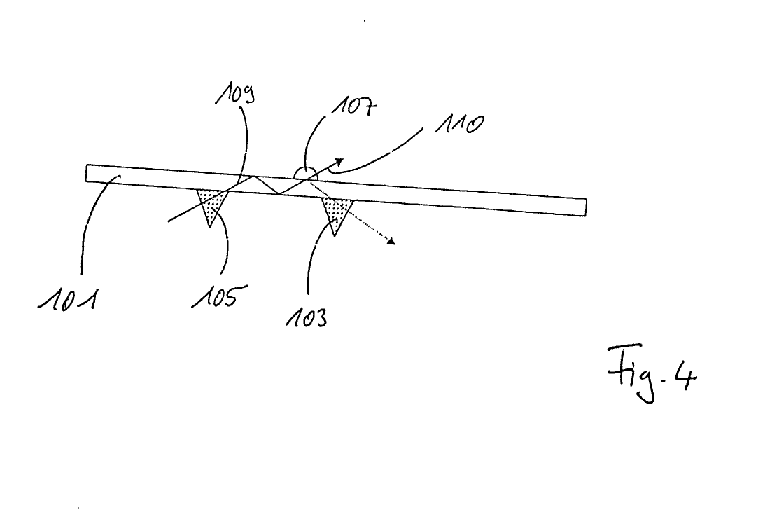

FIG. 4 shows such a known arrangement in schematic form. 101 designates the windscreen, 103 the ray uncoupling prism and 105 the ray coupling prism. The light ray 109 is totally reflected inside the windscreen when the surrounding medium is air. If a water droplet 107 is located on the windscreen, the light ray exits the windscreen and no longer reaches the ray uncoupling device 103.

With such a moisture sensor arrangement of the prior art, the ray coupling prism and the ray uncoupling prism respectively are fitted to the inside of the windscreen, whereby a non-smooth structure of the inside of the windscreen is created by the additional units.

Such a rain sensor cannot be located in the field of view of the vehicle driver as the additional structures result in a refraction or scattering of the light which should pass through the windscreen. Such reflection effects are naturally detrimental to safety. The rain sensor must accordingly be formed in a region of the windscreen which is not in the field of view and is as small as possible. For this reason, such rain sensors are located, for example, in the region of an adhesive fastening of a rear-view mirror.

To ensure that both the light source and the receiver and the ray coupling device and the ray uncoupling device respectively form a compact unit in total, the ray coupling device and the ray uncoupling device must be close together. This restricts the measuring range and the precision to one or a few total reflections between the ray coupling and the ray uncoupling.

Starting from this prior art, it is the object of the present invention to provide a moisture sensor which allows a larger measuring range.

This object is solved by a moisture sensor having the features of claim 1 or by a moisture sensors having the features of claim 4.

Advantageous aspects of the invention are the subject of the dependent claims.

In accordance with the invention, a reflection hologram is provided on a part of the light guide layer or on the pane and has such a holographic structure that when a light ray is incident at an angle α, at which the light is totally reflected inside the light guide layer or the pane, a light ray is reconstructed at the interface between the reflection hologram and the light guide layer or the pane which extends substantially opposite to the incident light ray.

In one embodiment, the light guide layer is part of a moisture sensor array. In another embodiment, the pane, e.g. a windscreen, is used as the light guide layer.

The apparatuses in accordance with the invention offer the advantage, among others, of a large spatial measuring range. The reflection hologram is substantially transparent. Only light which is incident at a certain angle is used for the holographic reconstruction. The reflection hologram can accordingly be fitted at any point on the windscreen without the transparency of the windscreen substantially suffering thereunder. It is possible for the coupling unit and the uncoupling unit to be close together as a result of the reconstruction of the measuring light ray back into itself. The spatial measuring range is nevertheless not determined by the distance between the coupling unit and the uncoupling unit, but by double the distance between the coupling device and the uncoupling device respectively and the reflection hologram. A very much larger spatial measuring range can be utilised in this way so that a multiple total reflection is possible. The precision of the moisture measurement can be increased in this manner. In an extreme case, the total extent of the windscreen can be used.

Another advantage lies in the fact that the spatial measuring range can also cover the region of the windscreen in which the windscreen wiper is active. The moisture sensor will respond to just a few drops and set the windscreen wiper in motion, for example, only with a very low rainfall. With known rain sensors, the windscreen wiper as a rule does not sweep over the moisture sensor since it cannot be arranged in the field of view. The few raindrops therefore remain on the moisture sensor and the windscreen wiper is not switched off again. In the moisture sensor of the invention, the spatial measuring region can be swept over by the windscreen wiper. If only a low rainfall is present, just a few drops, which have resulted in the switching on of the windscreen wiper, are wiped away by this and the moisture sensor switches the windscreen wiper off again.

The layers of the moisture sensor, including the light guide layer, can be combined, for example, as a unit in a film which is applied to the windscreen. The light can, for example, be sent through the pane to the coupling element. In another embodiment, the individual elements are applied to the side facing away from the surface of a pane, on which the moisture is to be measured, such that the pane itself acts as a light guiding layer.

In an advantageous aspect of the invention, the coupling element comprises a transmission-holographic element with a reconstruction direction inside the light guide layer or the pane equal to the desired propagation angle in the layer or the pane when the light is incident from the direction of the light source. It is equally advantageous if the uncoupling element comprises a transmission-holographic element with a reconstruction direction in the direction of the receiver when the light is substantially incident to the uncoupling element at the propagation angle in the light guide layer or the pane. Such transmission-holographic elements can be designed in very compact and small form and allow a very precise determination of the ray direction. A further development provides that a single element is provided both as the coupling element and the uncoupling element. An even more compact design is possible in this way.

The light source can, for example, comprise a light-emitting diode (LED). A particularly directional light, which is defined in wavelength, can be obtained by an LED with an advantageous design.

As a rule, total reflection takes place in the region of the light guiding layer or the pane on which the transmission hologram and the reflection hologram are not located. If the transmission holograms and the reflection hologram are located at that side of the light guiding layer, the side facing away from the surface of the light guiding layer or plane on whose surface the moisture is to be detected, then an additional auxiliary reflector hologram structure can be provided between the reflection hologram and the transmission hologram. This auxiliary reflector hologram structure replaces the total reflection at the interface of the light guiding layer or pane, which is not at the side on which the moisture is to be detected, with a holographic mirror.

In addition, a completely smooth surface of the overall moisture measuring system can thus be obtained on the pane or the light guiding layer with such an auxiliary reflector layer between the reflection hologram and the transmission hologram.

Such a an auxiliary reflector layer can also be advantageously used if that surface of the light guiding layer or pane, on which the transmission hologram and the reflection hologram are located, were to have no or only poor totally reflecting properties, e.g. due to moisture, contamination or roughness.

The auxiliary reflector hologram layer is designed such that when light is incident onto the interface between the light guiding layer and the auxiliary reflector hologram at an angle α, a light ray is reconstructed in a direction which corresponds to the angle β=180°−α. All in all, a situation therefore results which corresponds to the mirroring reflection.

The moisture sensors of the invention can be used particularly advantageously to control the windscreen wipers on aeroplanes or vehicles. This applies in particular if the pane itself is used as the light guiding layer. The moisture sensors of the invention can, however, also be used advantageously at other points at which the moisture on a surface has to be determined or an apparatus should be controlled in dependence on the moisture on a surface.

In the following, embodiments of the moisture sensor of the invention are explained for the example of rain sensors with reference to the attached drawings, which show

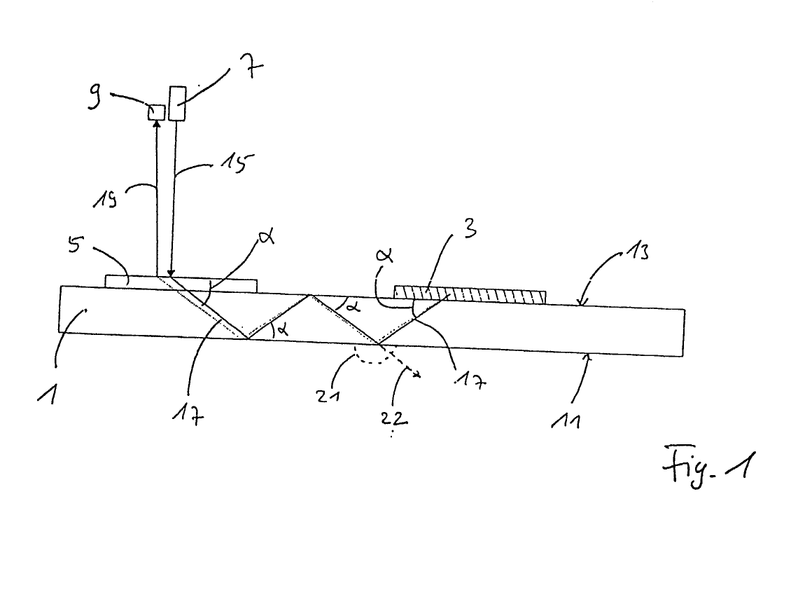

FIG. 1 the function principle of a moisture sensor of the invention in schematic form;

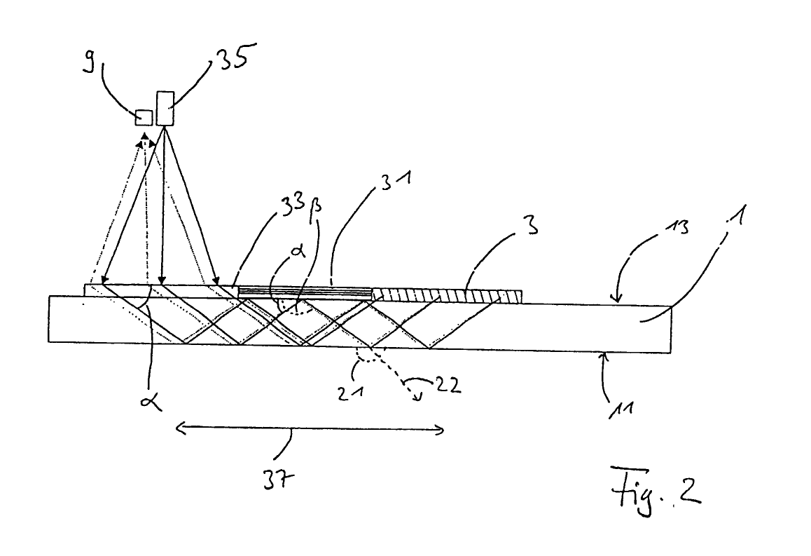

FIG. 2 an embodiment of the invention of a rain sensor of the invention in a schematic view;

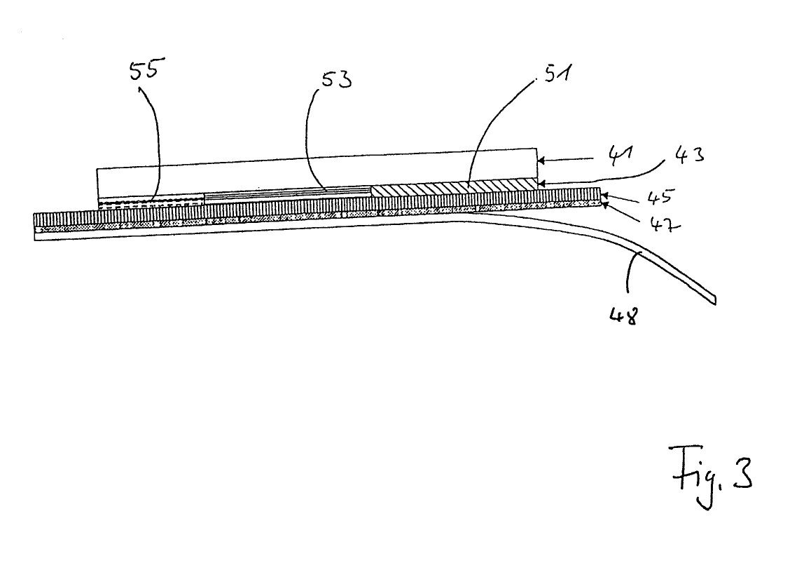

FIG. 3 a side sectional view of a part of an embodiment of a moisture sensor of the invention; and

FIG. 4 a schematic part view of a known rain sensor.

FIG. 1 shows an LED 7, for example a laser diode, which emits light in the direction of a transmission hologram 5 for coupling into the light guiding layer 1. A light ray 15 is indicated representatively. The transmission hologram is designed in a known manner such that when light is incident from the direction of the light source 7, it reconstructs a light ray 17 which propagates at an angle α in the light guiding layer 1, with the transmission hologram 5 being selected such that the angle α allows a total reflection at the interface between the light guiding layer 1 and the surrounding air.

The angle region for a total reflection can be calculated in a known manner from the refractive indices of the light guiding layer 1 and the respectively adjoining media. The maximum angle between the interface and the direction of incidence at which total reflection takes place can be calculated according to the formula cos α_{G}=(refractive index of the adjoining medium)/refractive index of the light guiding layer). The angle α_{G}=48° results for glass as the light guiding layer with a refractive index of 1.5 and air as the adjoining medium with a refractive index of 1. Directions of incidence which are incident to the interface between the light guiding layer and the environment at a smaller angle are reflected totally.

The light ray 17 is totally reflected multiple times at the angle α until it reaches the reflection hologram 3. This reflection hologram is designed such that when a light ray is incident at the angle α, it reconstructs a further light ray which in turn extends substantially back at the same angle.

The light can exit the light guiding layer 1 in the region of the reflection hologram 3 since a different condition applies for the total reflection there than when air is the surrounding medium.

The ray extending back through the light guide layer 1 is in turn incident on the transmission hologram. A light ray is reconstructed here which reconstructs in direction 19, substantially the same direction from which the incident light ray 15 has come. A detector 9, for example a photo cell, for the measurement of the incident light intensity is located in the ray path of the light 19.

The light guiding layer 1 can be an appropriate film with a selected refractive index or a glass pane, for example the windscreen of a motor vehicle. 13 designates the inner surface of this windscreen and 11 the outer surface. A water droplet 21 is indicated by a broken line. The surrounding medium of the light guiding layer 1 in the region of such a water droplet is not air, but water. The corresponding conditions for the total reflection change here. The critical angle for total reflection, for example in the transition from glass (refractive index=1.5) to water (refractive index=1.3) results in α_{G}=30° in accordance with the known formula cos α_{G}=(refractive index of water)/(refractive index of glass). In an embodiment with a light guiding layer or a windscreen of glass and surrounding air, the usable angle range therefore results of α from 30 to 48°. It is thus ensured that when water is present on the outer surface 11 of the glass pane 1, no total reflection occurs and the light ray exits the glass pane in the direction 22, as is indicated by a broken line in FIG. 1. The light ray is totally reflected when no water is present.

The function according to FIG. 1 is as follows: light from the diode 7 is incident to the transmission hologram and is coupled into the light guiding layer or the windscreen 1 at the angle α. With a dry surrounding, the light ray 17 is totally reflected at the interface between the light guiding layer or the pane 1 to the surrounding air until it reaches the reflection hologram 3. It is there reconstructed back into itself and passes substantially the same way in reverse. It again exits through the transmission hologram 5 and is there reconstructed in the direction of the detector 9. The intensity which is detected at the detector should substantially correspond to the intensity emitted by the light source 7 at least for a selected wavelength.

If a water droplet 21 or moisture is located on the outer surface 11 of the light guiding layer 1 or the pane, then the condition for the total reflection changes in the manner described above. The light ray is no longer totally reflected in such a region and exist the glass pane or the light guiding layer 1 in the direction 22. Less light or no light at all accordingly reaches the reflection hologram 3 and is reconstructed back into itself. The intensity of the light ray drops, which can be detected at the detector 9 in a reduction in the intensity at least for one wavelength. The intensity is equally reduced on the way from the reflection hologram 3 to the transmission hologram 5, where applicable.

In the event of a rain sensor for a windscreen wiper, a threshold value is set, whereby the windscreen wiper is automatically switched on when an intensity detected at the detector falls below this threshold value.

The transmission hologram 5 accordingly serves as an uncoupling unit and a coupling unit respectively and can be an embossed hologram which is easy to manufacture. The reflection hologram 3 in the embodiment shown is a volume hologram, for example a polymer layer, in which the holographic information was recorded.

FIG. 2 schematically shows an aspect of the moisture sensor of the invention. Here, a diode 35 is used which irradiates a certain angle region. A surface of the transmission hologram 33 is illuminated in this way. This is in turn designed such that it substantially reconstructs light which comes from the direction of the diode 35 in the same direction into the light guiding layer 1 at an angle α. The returning light is reconstructed by the transmission hologram 33 such that it is incident to the detector 9. Otherwise, the functional principle corresponds to the embodiment of FIG. 1.

The region 37 is the sensitive region. If a water droplet or moisture is incident to the outer surface 11 of the pane or the light guiding layer 1 in this region, then a corresponding part of the light incident to the interface is not totally reflected in the layer and is lost for the intensity measurement. The signal at the detector becomes accordingly lower and can be used to control the windscreen wiper, for example.

In the embodiment, an auxiliary reflector hologram structure 31 is additionally shown. This is designed such that light incident at an angle α, is holographically reconstructed at an angle β which corresponds to (180°−α). The auxiliary reflector hologram acts like a conventional mirror to this extent. The total reflection which is prone to interference is thus replaced. In addition, a smooth surface results on the inner side of the light guiding layer or the pane due to the additional auxiliary reflector hologram, said surface being formed by the transmission hologram 33, the auxiliary reflector hologram 31 and the reflection hologram 3.

In the above-described embodiments, the windscreen of an aeroplane or a vehicle is, for example, used as the light guiding layer 1.

A possible film structure for use in an embodiment of the invention is shown in a schematic view in FIG. 3. The hologram layer 43 here comprises the reflection hologram 51, the auxiliary reflector hologram 53 and the transmission hologram 55, corresponding to the elements 3, 31 and 33 as are visible in FIG. 2. The hologram layer 43 is applied to a carrier layer 45, for example a film structure. This is located on an adhesive layer 47. The whole structure can be covered by a protective layer 41. The adhesive layer is covered by a paper layer 48 prior to use. This paper 48 is pulled off for use and the film with the adhesive layer 47 adhered, for example, to the windscreen of a motor vehicle.

The refractive indices of the carrier layer and the adhesive layer should correspond as far as possible to the refractive index of the material onto which the structure is adhered, that is, for example, have a refractive index of around 1.5 corresponding to glass so that the light ray is not changed in its direction on the transition from the carrier layer into the adhesive layer or into the light guiding layer on which the adhesive layer is applied.

A moisture sensor is therefore provided by the apparatus of the invention which can have a large spatial measuring range. The size of the measuring range does not depend on the distance of the coupling unit and uncoupling unit, but on the distance of the reflection hologram from the coupling unit and the uncoupling unit. The whole structure is transparent so that it can be applied, for example to a windscreen, also in the field of view of the driver. The measuring accuracy increases due to the large measuring range due to the greater number of total reflections in the measuring range.

1. A moisture sensor comprising a light source;
a light guiding layer;
a coupling element for the coupling of light into the light conducting layer at an angle α between the coupled light ray and the surface of the light guiding layer at which the light of at least one wavelength undergoes total reflection in the light guiding layer, when the medium adjoining the light guiding layer has a moisture lower than a threshold moisture; and
does not undergo total reflection when the medium adjoining the light guiding layer has a moisture larger than the threshold moisture;
an uncoupling element for the uncoupling of the light from the light guiding layer; and
a detector for the uncoupled light, characterised by
a reflection hologram (3, 51) on a part of the light guiding layer (1) having such a holographically recorded structure that when a light ray (17) is incident at the angle a on the interface (13) between the reflection hologram (3, 51) and the light guiding layer (1), a light ray is reconstructed which runs essentially opposite to the incident light ray (17).

2. A moisture sensor in accordance with claim 1, wherein a pane is used as the light guiding layer (1).

3. A moisture sensor in accordance with claim 2, wherein the pane comprises a windscreen of a motor vehicle or an aeroplane.

4. A moisture sensor for affixing to a pane, in particular a windscreen of motor vehicles or aeroplanes, comprising
a light source;
a coupling element for the coupling of the light of the light source into a pane at an angle α between the coupling direction and the surface of the pane at which the light of at least one wavelength undergoes total reflection in the pane, when the medium adjoining the pane has a moisture lower than a threshold moisture; and
does not undergo total reflection when the adjoining medium has a moisture larger than a threshold moisture;
an uncoupling element for the uncoupling of the light from the pane; and
a detector for the uncoupled light, characterised by
a reflection hologram (3, 51) on a part of the light guiding layer (1) having such a holographic structure that when a light ray (17) is incident at the angle α on the interface between the reflection hologram (3, 51) and the light guiding layer (1), a light ray is reconstructed which runs essentially opposite to the incident light ray (17).

5. A moisture sensor in accordance with any of claims 1 to 4, wherein the coupling element (5, 55) is a transmission holographic element with a reconstruction direction in the light guiding layer (1) or the pane roughly equal to the angle α, when the light (15) is incident from the direction of the light source (7, 35).

6. A moisture sensor in accordance with any of claims 1 to 4, wherein the uncoupling element (5, 55) is a transmission holographic element with a reconstruction direction in the direction of the receiver (9) when the light is substantially incident at an angle a from the light guiding layer (1) or the pane.

7. A moisture sensor in accordance with claims 5 and 6, wherein the uncoupling element and the coupling element are formed by a one-piece element (5, 55).

8. A moisture sensor in accordance with any of claims 5 to 7, wherein the transmission holographic element(s) (5, 55) comprise an embossed hologram.

9. A moisture sensor in accordance with any of claims 5 to 7, wherein the transmission holographic element(s) (5, 55) comprise a photo polymer layer.

10. A moisture sensor in accordance with any of claims 1 to 9, wherein the reflection hologram (3, 51) comprises a photo polymer layer.

11. A moisture sensor in accordance with any of claims 1 to 10, characterised by a laser diode as the light source (9).

12. A moisture sensor in accordance with any of claims 1 to 11, wherein an auxiliary reflector hologram (31) is located on the light guiding layer (1, 45) or the plane respectively in a region between the coupling element (5, 55) and the reflection hologram (3, 51) and reconstructs a light ray in a direction β=180°−αbetween the light ray and the light guiding layer (1, 43) or plane respectively when a light is incident onto the interface between the light guiding layer (1) and the auxiliary reflector hologram at an angle α.

13. Use of a moisture sensor in accordance with any of claims 1 to 12 for the control of a windscreen wiper.
